(19) United States
(12) Patent Application Publication
(10) Pub. No.: US 2003/0066787 A1
(43) Pub. Date: Apr. 10, 2003

(54) Magnetic separation of ores using sulfonated polymers

(76) Inventors: Libardo A. Perez, Morrisville, PA (US); Donald C. Roe, Jamison, PA (US); David M. Polizzotti, Yardley, PA (US)

Correspondence Address: Steven D. Boyd, BetzDearborn Inc., 4636 Somerton Road, Trevose, PA, 19053-6783, US

(21) Appl. No.: 09/969,214

(22) Filed: Oct. 2, 2001

(51) Int. Cl. B03B 5/22; B07B 1/00

(52) U.S. Cl. 209/500

(57) ABSTRACT

A method of enhancing the magnetic separation of ores is disclosed in which a sulfonated polymeric dispersant is added to an ore slurry just prior to or during the magnetic separation operation. The sulfonated polymeric additive inhibits heterogeneous flocculation during the magnetic separation operation.

### FIELD OF THE INVENTION

The present invention is directed to the benefication of magnetic ores. More particularly, the present invention is directed to the benefication of low-grade ores via magnetic separation wherein the magnetic separation process is enhanced by the addition of sulfonated polymer dispersants to the magnetic separation operation.

### BACKGROUND OF THE INVENTION

The present invention is directed to the benefication of low grade, finely divided ores via a magnetic separation process. Such ores are typically upgraded by magnetic separation followed by flotation. The settling of particles in the solutions which have relatively high concentrations of suspended solids is a problem in such ore processing. For example, magnetic separators take advantage of the difference in magnetic properties between ore minerals and is used to separate valuable minerals from non-magnetic gangue or non-magnetic minerals. The efficacy of a magnetic separation process can be greatly reduced by adsorption or agglomeration of non-magnetic particles around magnetic particles. That is, heterogeneous flocculation of the finely divided ore can hinder magnetic particles from separating in the magnetic fields, thereby reducing the recovery of the desired magnetic ore concentrate. Alternatively, impurities attached to magnetic ore particles can be recovered with the concentrate, thereby reducing the grade, or purity, of the magnetic ore concentrate.

The use of dispersant materials in ore processing is known. U.S. Pat. No. 4,298,169 discloses the addition of dispersants such as tannins, lignin sulphonates and alkaline phosphates to maintain a uniform dispersion of ore in water when the ore is ground. Thereafter, a flocculating agent is added to induce selective flocculation of magnetite and the flocculated ore is subjected to magnetic separation. U.S. Pat. No. 4,219,408 discloses a process of magnetic separation of minerals in which a dispersed aqueous slurry of ore is admixed with a system of ferromagnetic seed particles to enhance the magnetic separation process. The aqueous slurry is dispersed with dispersants such as sodium silicate, sodium hexametaphosphate and sodium polyacrylate/sodium hexametaphosphate. U.S. Pat. No.5,307,938 discloses a method of increasing iron ore recovery by adding a dispersant polymer or copolymer containing at least one acrylic functional group to the ore during the grinding operation. The polymer is added to deslime thickeners (settling tanks) where the ore is allowed to settle and silica is decanted and removed as overflow.

### SUMMARY OF THE INVENTION

The present invention is directed to a method of enhancing magnetic separation processes for ore recovery. The method comprises the addition of sulfonated polymeric dispersants to an ore slurry just prior to or during magnetic separation. The addition of sulfonated polymeric dispersants just prior to or during the magnetic separation operation has been found to inhibit heterogeneous flocculation in the magnetic separation operation which adversely impacts the efficacy of the magnetic separation process.

### DETAILED DESCRIPTION OF THE PREFERRED EMBODIMENT

Although the method of the present invention is applicable to all ores which may be separated by selective flocculation and magnetic separation, the invention is illustrated by specific reference to iron ores. The present invention proceeds according to existing processing of ore in which selective flocculation and magnetic separation processes are employed.

In typical iron ore processing, the discharge from the grinding mill is diluted to between 5 and 40 percent solids and mixed with a flocculating agent to induce selective flocculation of iron oxides on nuclei of particles containing residual magnetite. The flocculating materials are selected to cause selective flocculation of the iron oxide in preference to silica materials. Examples of flocculants are carbohydrates such as corn starch, potato starch and other natural and modified starches; ammonium algenate; carboxomethyl cellulose; cellulose xanthate; and synthetic polymerized flocculents such as polyethylene oxide, polyacrylamides and polyacryls nitrites. In the prior art, the suspension of ore and flocculents are agitated briefly. The selectively flocculated ore pulp is then fed to a magnetic separation operation such as a magnetic surface or porous ferro magnetic matrix.

The present inventors have discovered that the magnetic separation of the iron oxide of the prior art can be enhanced by the addition of sulfonated copolymers or terpolymers or mixtures thereof to the ore slurry just prior to or during the magnetic separation operation. The addition of sulfonated copolymers or terpolymers just prior to or during the magnetic separation operation was discovered to disperse the suspended iron particles and reduce or eliminate undesirable heterogenous flocculation in the magnetic separation operation.

In the present invention, the sulfonated copolymers or terpolymers are added to the ore slurry just prior to or during the magnetic separation operation. The sulfonated copolymers or terpolymers act as dispersants that inhibit heterogeneous flocculation in the magnetic separation operation. By inhibiting heterogeneous flocculation, the efficacy of the magnetic separation operation is enhanced.

The sulfonated copolymers or terpolymers are added to the aqueous ore slurry in a concentration of from abut 1 to about 200 parts active polymer per one million parts aqueous ore slurry (ppm). Preferably the sulfonated copolymers or terpolymers are added to the aqueous ore slurry in a concentration of from about 5 to about 60 ppm.

The dispersant efficacy of the sulfonated copolymers or terpolymers of the present invention is demonstrated by the following example. The following example is intended to be illustrative of the present invention and not restricting the scope of the present invention.

### EXAMPLES

The dispersant efficacy of a variety of materials on a mineral ore slurry containing 8% suspended solids was evaluated. The mineral ore slurry was placed in turbidimeter cells, shaken to ensure complete dispersion of the solids and inserted into a Hach turbidimeter. Turbidity readings were taken over a ten hours. For treatments that exhibited a drop in dispersing efficacy, readings were terminated in less than ten hours. Treatment performance was compared to a control in which no treatment was added. Tables I and II summarize the results.

TABLE I

| Treatment | Dosage | Turbidity (NTU) | Timed Reading (hours) |
|---|---|---|---|
| AA/AHPSE (3:1,low MW) | 10 ppm | 9911 | 10 |
| Sodium Hexametaphosphate | 10 ppm | 6729 | 10 |
| Lignosulfonic acid, | 10 ppm | 6041 | 10 |
| ammonium salt | | | |
| Sodium Polymethacrylate | 10 ppm | 2668 | 10 |
| AA/PEGAE (2.%:1, 10 moles EO) | 10 ppm | 1712 | 4.92 |
| Carboxymethylcellulose | 10 ppm | 1320 | 10 |
| AA/AHPSE (3:1, high MW) | 10 ppm | 1297 | 10 |
| PIPA | 10 ppm | 1149 | 5.83 |
| Sodium Tripolyphosphate | 10 ppm | 929 | 1.84 |
| Lignosulfonic acid, sodium | 10 ppm | 911 | 2.71 |
| salt | | | |
| Control | 0 ppm | 234 | 2.02 |
| Control | 0 ppm | 157 | 1.75 |
| Polyoxyethylene thioether | 10 ppm | 151 | 3.45 |

TABLE II

| | | | |
|---|---|---|---|
| Ter(acrylic acid/t- | 5 ppm | 8979.7 | 10 |
| butylacrylamide/AMPS), | | | |
| MW = 5000 | | | |
| AA/AHPSE (3:1, low MW) | 5 ppm | 8872 | 10 |
| AA/AHPSE (6:1) | 5 ppm | 2703.9 | 10 |
| AA/AMPS | 5 ppm | 1967.9 | 10 |
| Diisobutylene maleic | 5 ppm | 1914.4 | 10 |
| anhydride copolymer | | | |
| Ter(acrylic acid/t- | 5 ppm | 1202.2 | 10 |
| butylacrylamide/AMPS), | | | |
| MW = 4500 | | | |
| Sodium Hexametaphosphate | 5 ppm | 1101 | 3.4 |
| Polyacrylic acid | 5 ppm | 964.57 | 10 |
| Control | 0 ppm | 828 | 4.92 |
| Lignosulfonic acid, | 5 ppm | 739 | 2.21 |
| ammonium salt | | | |
| Sodium polystyrene | 5 ppm | 590.35 | 5.82 |
| sulfonate | | | |
| Dicarboxyethyl N alkyl | 5 ppm | 245.84 | 3.07 |
| (C 18) sulfosuccinate | | | |
| Control | 0 ppm | 145.4 | 3.42 |
| Polymaleic acid | 5 ppm | 32.54 | 7.59 |

In tables I and II, AA/AHPSE is Acrylic acid/ allylhydroxpropyl sulfonate ether, AA/PEGAE is Acrylic acid/polyethylene glycol allyl ether, PIPA is polyisopropylene phosphonic acid, AA/AMPS is Acrylic acid/acrylamide methylpropane sulfonic acid.

The data is tables I and II shows that sulfonated copolymers or terpolymers exhibit surprising efficacy at improving dispersion of the ore slurry which will result in improved efficacy in the magnetic separation operation. The non-sulfonated materials tested did not exhibit comparable efficacy in dispersing the ore slurry.

While the present invention has been described with respect to particular embodiments thereof, it is apparent that numerous other forms and modifications of the invention will be obvious to those skilled in the art. The appended claims and this invention generally should be construed to cover all such obvious forms and modifications which are within the true spirit and scope of the present invention.

What is claimed is:

1. A method of magnetically beneficiating an ore by separating therefrom inorganic metal oxide of inherently low magnetic attractibility which is present in said ore as an undesired species comprising:
forming a dispersed aqueous slurry of said ore including metal oxide;
mixing said slurry with at least one sulfonated polymer in a concentration of from about 1 ppm to about 200 ppm active polymer;
subjecting the resulted slurry to magnetic separation means; and
recovering as product beneficated ore.

2. The method of claim 1 wherein said at least one sulfonated polymer is selected from the group consisting of sulfonated copolymers, sulfonated terpolymers and mixtures thereof.

3. The method of claim 2 wherein said at least one sulfonated polymer is selected from the group consisting of acrylic acid/allylhydroxypropyl sulfonate ether, lignosulfonic acid ammonium salt, acrylic acid/acrylamide methylpropane sulfonic acid, and mixtures thereof.

4. The method of claim 1 wherein the concentration of said at least one sulfonated polymer is from about 5 to about 60 ppm active polymer.

5. The method of claim 1 wherein said magnetic separation means comprises a porous ferro magnetic matrix.

6. The method of claim 1 wherein said magnetic separation means comprises a magnetic surface.
